(19) United States
(12) Patent Application Publication
(10) Pub. No.: US 2006/0090166 A1
(43) Pub. Date: Apr. 27, 2006

(54) System and method for generating applications for communication devices using a markup language

(76) Inventors: Krishna Dhara, Dayton, NJ (US); Vankatesh Krishnaswamy, Holmdel, NJ (US)

Correspondence Address: Ryan, Mason & Lewis, LLP;Suite 205, 1300 Post Road, Fairfield, CT, 06824, US

(21) Appl. No.: 10/955,919

(22) Filed: Sep. 30, 2004

(51) Int. Cl. G06F 9/44

(52) U.S. Cl. 719/318

(57) ABSTRACT

Methods and apparatus are provided for generating applications for communication devices. An IP Terminal Markup Language (IPTML) is disclosed that modifies the operation of communication devices. IPTML allows abstraction of call control, media control and device control aspects of a communication device. An IPTML construct distributes intelligence between communication devices, allows applications to interact with a wide range of devices with varying capabilities and provides end-point functionality that enables converged applications at communication devices. When a communication device is operating, abstraction data related to the communication device is accessed in order to generate an application that modifies the operation of the communication device as a function of the abstraction data.

### FIELD OF THE INVENTION

The present invention relates generally to techniques for generating applications for various communication devices and, more particularly, to techniques for generating applications for communication devices having varying capabilities.

### BACKGROUND OF THE INVENTION

Communication devices must typically provide various functions in order to implement applications. For example, applications may need to monitor or control events on a device, issue directives to the device or render user interface events at the device. There is significant variation, however, in the functionality available on commercially available devices. In addition, a number of applications may require inter-operation among a number of devices, such as a personal computer and an office telephone.

A number of signaling protocols have been proposed to define how devices communicate. The Session Initiation Protocol (SIP), for example, may be used for network communications, such as Internet conferencing, telephony, and Instant Messaging. Such existing signaling protocols, however, do not specify how to distribute functionality between communication devices.

In addition, a number of web-based user-experience frameworks, such as the Hyper Text Markup Language (HTML) and Wireless Application Protocol (WAP), have been proposed to allow devices to access information over a network. Typically, such frameworks make information self-describing, thereby making it easier to define document types and to write programs to handle the documents. Such web-based user-experience frameworks, however, do not specify how to distribute communication functionality between communication devices.

A need therefore exists for improved methods and apparatus for generating applications for communication devices. A further need exists for a mechanism for describing the behavior of communication devices.

### SUMMARY OF THE INVENTION

Generally, the present invention provides methods and apparatus for generating applications for communication devices. According to one aspect of the invention, an IP Terminal Markup Language (IPTML) is disclosed that modifies the operation of communication devices. IPTML allows abstraction of call control, media control and device control aspects of a communication device. An IPTML construct distributes intelligence between communication devices, allows applications to interact with a wide range of devices with varying capabilities and provides end-point functionality that enables converged applications at communication devices.

Method and systems are disclosed for generating an application for a communication device. When a communication device is operating, abstraction data related to the communication device is accessed in order to generate an application that modifies the operation of the communication device as a function of the abstraction data.

IPTML encapsulates several features of a communication device in a device abstraction layer. The device abstraction layer consists of abstractions for (i) device control and event reporting functions; (ii) configuration and discovery of device communication capabilities; (iii) providing links to presentation, input collection and web content; and (iv) scripting capabilities for aggregated device control.

A more complete understanding of the present invention, as well as further features and advantages of the present invention, will be obtained by reference to the following detailed description and drawings.

### BRIEF DESCRIPTION OF THE DRAWINGS

FIG. 1 illustrates a network environment in which the present invention can operate;

FIG. 2 shows a detailed view of selected elements of FIG. 1;

FIGS. 3A through 3E show representations of IPTML constructs;

FIG. 4 is an algorithm to modify operation of a communication device;

FIG. 5 is an algorithm to generate a response to a communication event using a coupled telephone and personal computer;

FIG. 6 is an algorithm to generate a response to a communication event using a portal framework; and

FIG. 7 is an algorithm to generate a response to a communication event using a peer-to-peer framework.

### DETAILED DESCRIPTION

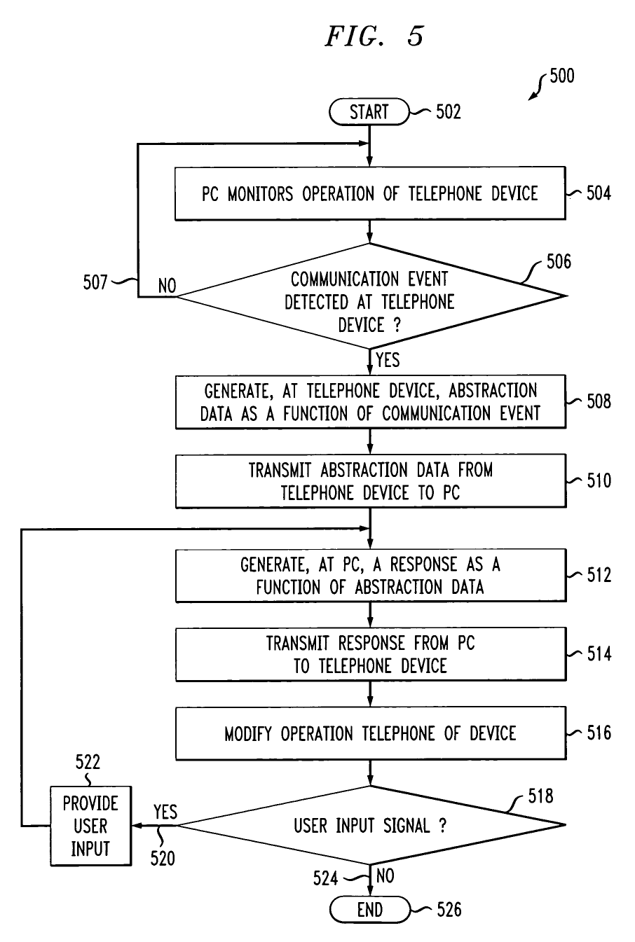

As discussed further below in conjunction with FIGS. 5 through 7, respectively, the present invention may be applied in various applications (i) to couple a telephone to a personal computer, for example, to initiate a video component of a communication session after a voice call has been initiated; (ii) to provide a portal framework for telephones and other “thin client” devices that do not provide a processing capability; and (iii) to peer-to-peer application level negotiation.

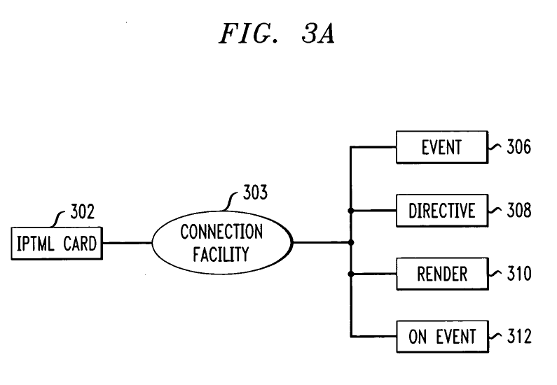

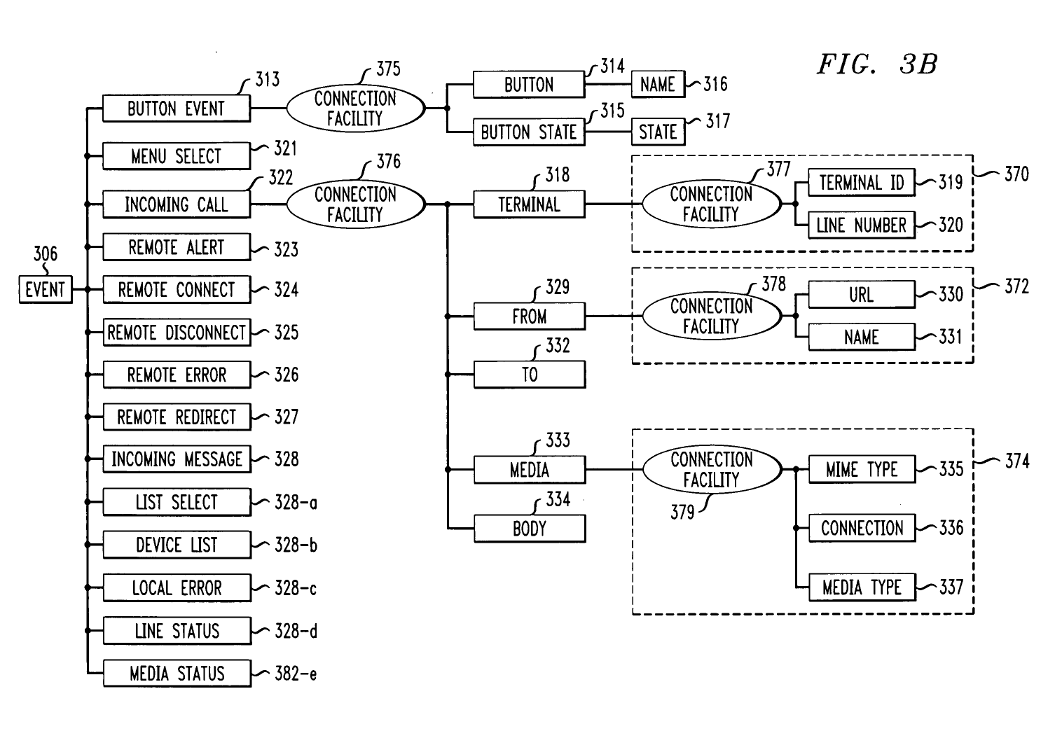

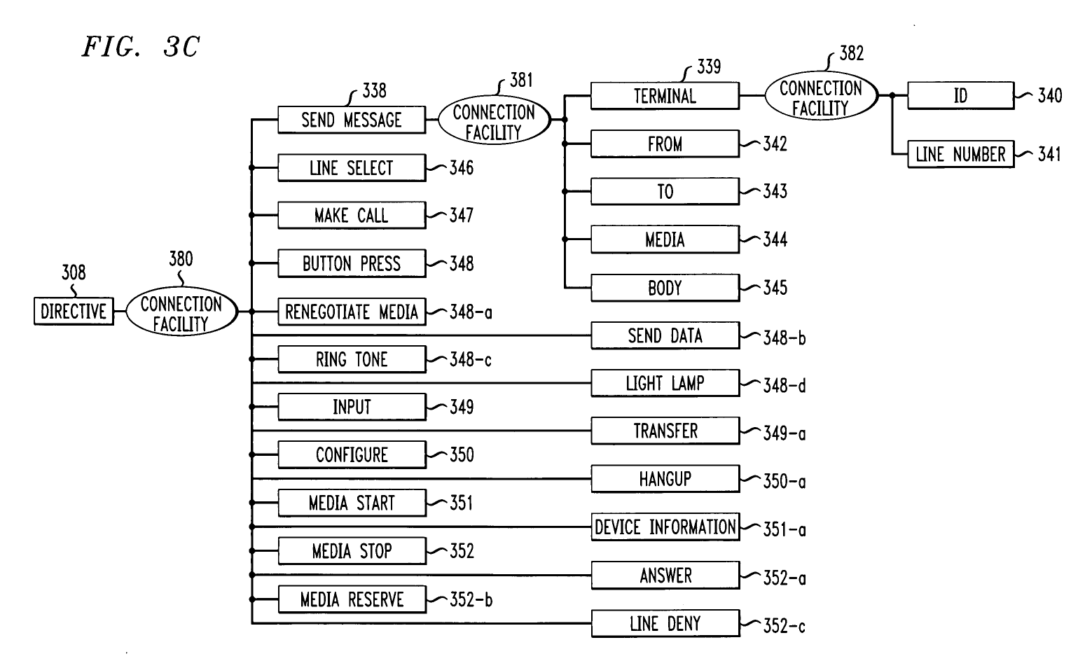

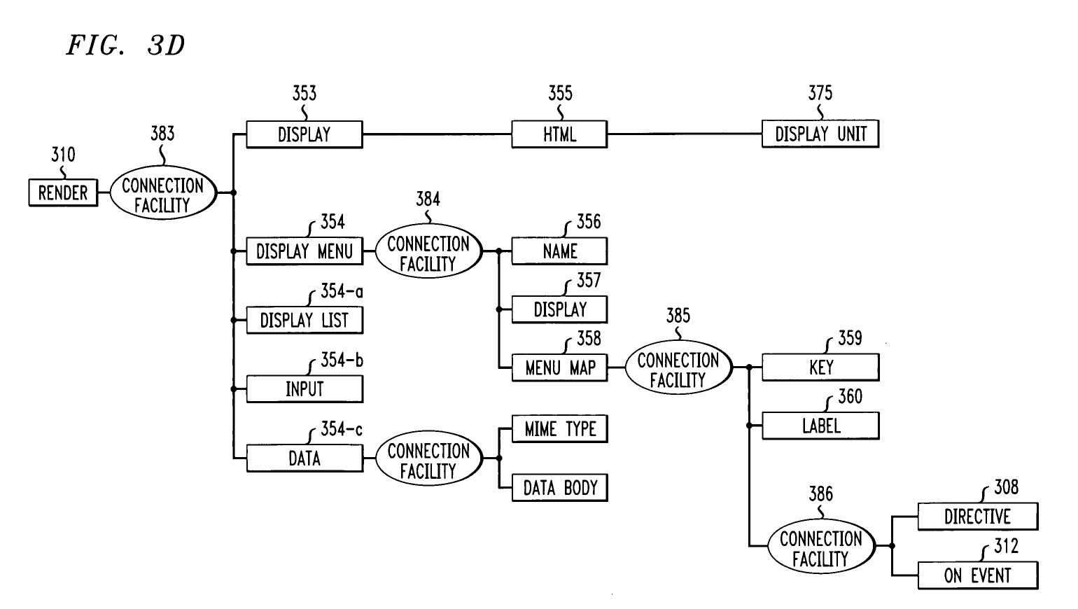

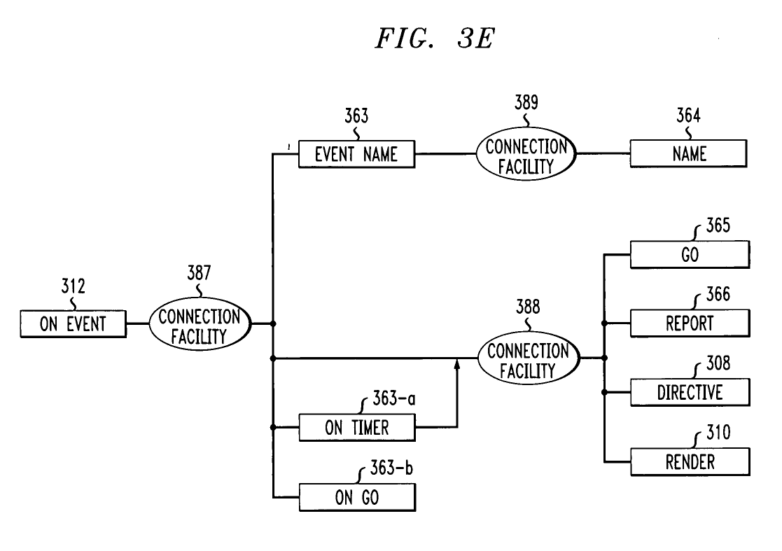

As disclosed herein, IPTML provides an application-layer pervasive environment with the ability to interact with communication activity at end-devices. The disclosed IPTML is a meta-language for defining markup languages, such as XML (Extensible Markup Language), that extend beyond single-party call/communication device control for a communication device, such as an Internet Protocol (IP) communication device, an application, or a combination thereof. Among other features, IPTML allows communication activity of an end-device to be abstracted and reported. To enable this, IPTML encapsulates several features of a communication device in a device abstraction layer. As discussed below in conjunction with FIG. 3, this device abstraction layer consists of the following abstractions:
(i) device control and event reporting functions;
(ii) configuration and discovery of device communication capabilities;
(iii) providing links to presentation, input collection and web content; and
(iv) scripting capabilities for aggregated device control.

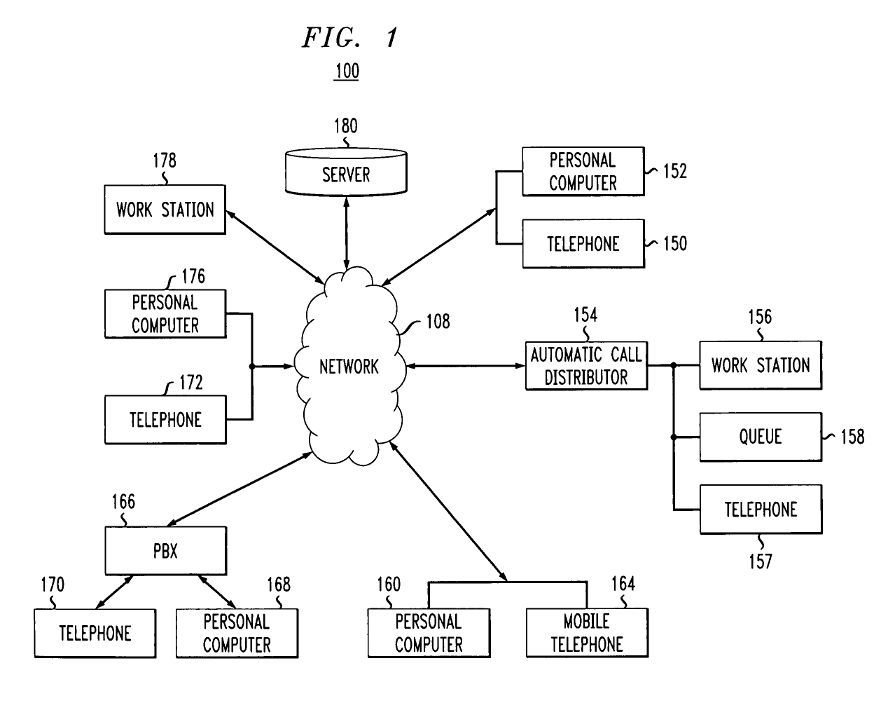

FIG. 1 illustrates a network environment 100 in which the present invention can operate. As shown in FIG. 1, the network environment 100 includes various types of communication devices connected over a network 108. It is noted that the various communication devices shown in FIG. 1 is for illustrative purposes and that a given application may not require all such communication devices, as would be apparent to a person of ordinary skill in the art. The network 108 may be embodied using any combination of wired or wireless network topologies. In accordance with one aspect of the invention, two or more of the communication devices are adapted to communicate with one another using an IPTML construct. The communication devices may include, for example, telephones, computers, hand-held devices, facsimile machines, scanners, printers, mobile telephones, personal digital assistants (PDAs), wireless electronic mail clients, mobile devices, for example, using Short Message System (SMS) or a similar transport mechanism, multiprocessor systems, microprocessor-based or programmable consumer electronic devices.

In the exemplary network environment 100 of FIG. 1, the communication devices include a telephone 150 coupled to a personal computer 152; an automated call distributor (ACD) 154 coupled to a workstation 156, telephone 157 and call queue 158; a personal computer 160 coupled to a mobile telephone 164; a Private Branch Exchange (PBX) switch 166 connecting a personal computer 168 and a telephone 170; a telephone 172 coupled to a personal computer 176; a workstation 178; and a server 180, such as a voice mail server. It is noted that the PBX 166 may alternatively be implemented using proxy techniques, as would be apparent to a person of ordinary skill.

The network 108 provides client-server type application services for communication devices (shown as devices 150, 152, 154, 156, 157, 158, 160, 164, 166, 168, 170, 172, 176, 178 and 180) by enabling the communication devices to request application services from remote servers using standardized protocols, such as HTTP (Hyper Text Transfer Protocol). For example, communication device 178 is a workstation that can access a remote web application server that executes a set of application services, via network 108.

The communication devices are arranged to transmit and/or receive transmission events based on the capability of the particular device. Transmission events include, for example, incoming telephone calls, voice data, email data, instant messages (I/M), facsimiles, scanned data, photographic data, audio streams, image data and video data.

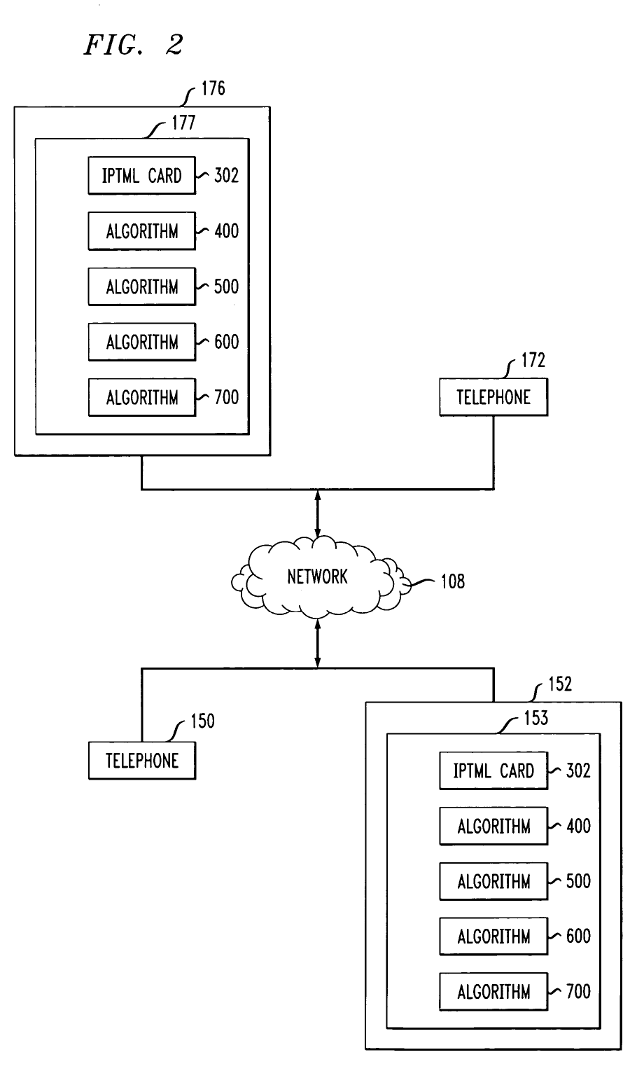

FIG. 2 illustrates a number of elements of FIG. 1 in further detail. More specifically, FIG. 2 shows telephone 150, associated personal computer 152, telephone 172, associated personal computer 176, and network 108. FIG. 2 is used to describe an example of IPTML generating applications for communication devices (for example, telephones 150 and 152).

Telephone 150 preferably features a display screen for displaying text, graphical and video information, such as a GUI (graphical user interface). The display screen can optionally be integrated with a touch screen. In addition, the telephone 150 optionally provides function buttons for receiving user input and software scripting functionality that enables customization according to a request of the user, such as scripts provided as HTML pages and scripts, such as JavaScripts.

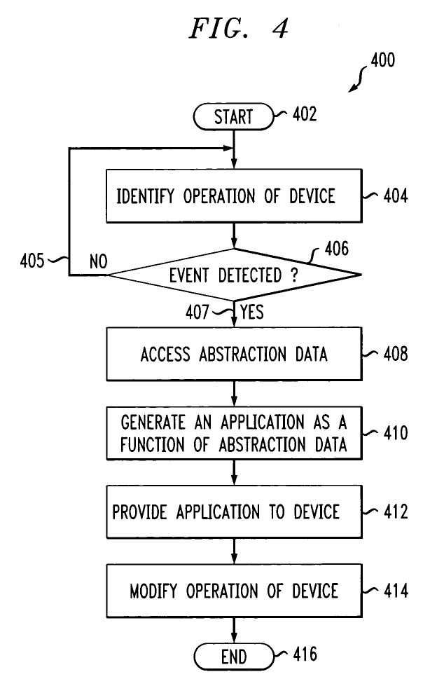

The personal computer 152, which is operatively coupled to telephone 150, includes a memory 153 that stores an IPTML Card 302 (discussed below in conjunction with FIGS. 3A-3E) and algorithms 400, 500, 600 and 700 (discussed below in conjunction with FIGS. 4 through 7, respectively).

Telephone 172 may be a thin client communication device that does not provide a processing capability and does not have a display screen, and thus is not able to receive user input. Regardless of the processing or other capabilities of telephone 172, the telephone 172 can be used with the IPTML construct in accordance with the present invention.

Personal computer 176 is operatively coupled to telephone 172 and includes a memory 177 storing IPTML Card 302 and algorithms 400, 500, 600 and 700.

Thus, while the communication devices (telephone 150, personal computer 152, telephone 172 and personal computer 176) may have different capabilities, the IPTML Card 302 of the present invention allows information and functionality to be distributed between the communication devices. For example, the IPTML Card 302 operating on personal computer 176 can expand the features of thin client telephone 172 by providing custom alerts and expanded speed dial lists that would not be available to thin client telephone 172 without the IPTML Card 302 of personal computer 176.

Abstraction of Communication Devices, Signal Data and Media Data

Communication device data represents the abstraction that is a function of an identification of a lineset and a linenumber. A lineset represents an identity of the communication device by which a user can receive or transmit transmissions, such as telephone calls, electronic communications and video communications. For example, a lineset name of john@host1.domain.com represents telephone 172 that can be addressed as john@host1.domain.com. Similarly, transmissions originating from this lineset would be identified as being from john@host1.domain.com and may also include a display name associated with it. The lineset name could also be a number.

Each communication device 150, 152, 172 and 176 typically has at least one lineset name and may have many names. Any outgoing transmission can be made through one of the linesets. Incoming transmissions, such as calls, are addressed to one of the linesets that are provided on the device. Providing a lineset involves identifying the number of lines each lineset can have, and any other server/proxy/registrar information this lineset might be using to receive and to place calls. Incoming and outgoing messages, including I/M's, also identify a lineset that is configured to receive and transmit messages.

In addition to lineset, linenumber is another abstraction that represents a state of a communication session. Each lineset can have multiple lines. Thus, a call on linenumber 0 on lineset name john@host1.domain.com would be different than a call on linenumber 1 on lineset name john@host1.domain.com. Linenumber 0 holds a different call state than linenumber 1. Switching between two calls involves a user action of selecting the appropriate line on a user interface.

Implementation of the linenumber abstraction, either as a terminal or as a part of another application, can reserve a linenumber on a lineset to place a call or to send an instant message. This reservation would launch a session that must be explicitly terminated. Similarly, an incoming call on a lineset would choose a line on the lineset that is available and launches a session between the two parties. A session ends when the remote party hangs up or local party terminates the call.

Physical mapping of the linesets and the linenumbers depends on the communication device. Similarly, the management of the sessions or calls is implemented by the application that ties the terminal abstraction to a specific call-control protocol.

According to another aspect of the present invention, IPTML enables signal data to be represented as an abstraction. The signal data is typically a result of a communication event at a communication device. These communication events are discussed in more detail in relation to the event construct of FIG. 3B.

In addition, IPTML enables media data to be represented as an abstraction. The media data is a type of data, such as voice, text or graphic data, that can be transmitted between parties to a communication session. The media data is discussed in more detail in relation to the event construct of FIG. 3B.

FIGS. 3A through 3E show representations of IPTML constructs. Abstraction data includes an IPTML construct, abstraction of a communication device or an abstraction of an event at a communication device. An overview of IPTML is discussed in relation to FIG. 3A. The main constructs in IPTML are Events (discussed in relation to FIG. 3B), Directives (discussed in relation to FIG. 3C), Render (discussed in relation to FIG. 3D), and a scripting mechanism referred to as “OnEvent” (discussed in relation to FIG. 3E). While OnEvent combines different capabilities, the rest of the three constructs represent various aspects of IP voice terminals.

The IPTML construct, shown for example as IPTML Card 302, enables design of user-experiences for interactive multi-modal communication devices by specifying application-level behavior across protocol-connected peers. Applications often require different capabilities such as monitoring events on a communication device, controlling events at the communication device, issuing directives, or commands, to communication devices, rendering user interface (UI) events on the communication device, decoupling media, signaling, and communication device events, and a combination of all of the above abilities. The IPTML construct combines these capabilities with scripting mechanisms (“OnEvent”). This combination permits applications to render IPTML documents on communication devices with remote decision making or render communication devices with scripts that are capable of local decision making. This allows IPTML to support applications that can drive both intelligent terminals and thin-client terminals. The IPTML constructs may be communicated as attachments to SIP dialog requests and responses, through SIP events, out-of-band (through redirect and call-information header, application streaming setup using SDP (Streaming Download Project).

FIG. 3A shows an IPTML Card 302, as shown in FIG. 2, in more detail. IPTML construct 302 includes connection facility 303, which permits a choice of one or more IPTML constructs 306, 308, 310 and/or 312. IPTML constructs are organizational schemes and include navigational paths between IPTML elements to perform a particular function. IPTML Card 302 is defined in terms of an Event construct 306 Directive construct 308, Render construct 310 or OnEvent construct 312.

The IPTML Card 302 may be used in conjunction with a particular application, since particular applications, such as SIP (Session Initiation Protocol), do not provide an application layer. For example, IPTML is used in conjunction with SIP to combine an abstraction with communication device features.

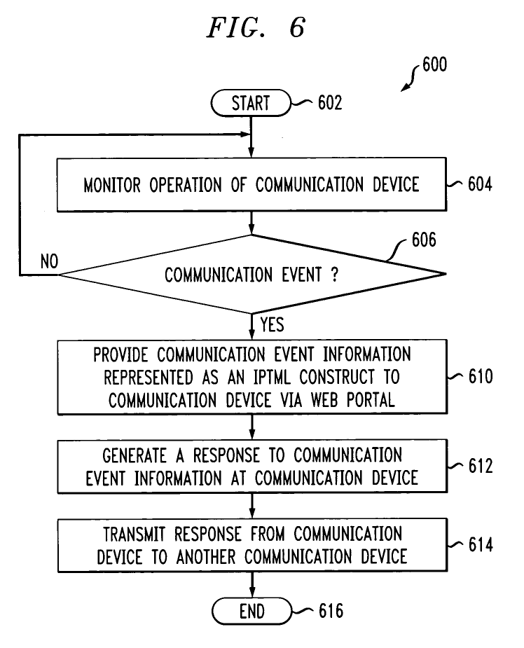

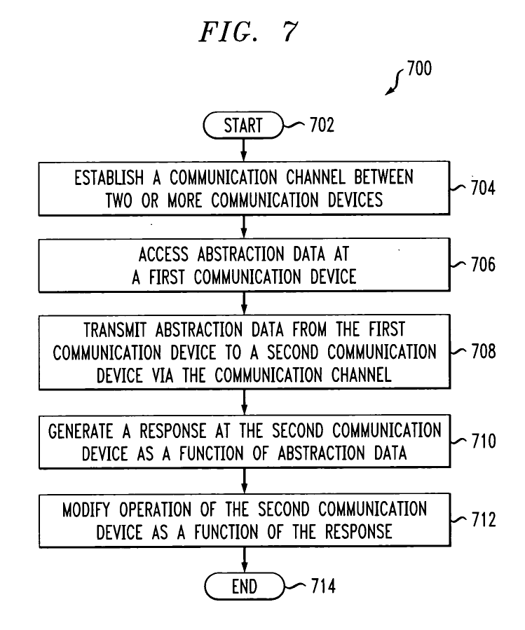

While any suitable protocol may be used with the IPTML Card 302, SIP is one exemplary protocol. SIP is a signaling protocol for Internet conferencing, telephony, presence, events notification and instant messaging is a suitable transport protocol since it provides a peer-to-peer model enables an enhanced set of applications than protocols that support only a pull model. Transporting IPTML over SIP enables applications classes where peer user agents (UAs), which are typically arranged to drive a thin client, can be tightly coupled (such as a phone and a personal computer, discussed in relation to FIG. 5) or a peer-to-peer in-call coupling framework (such as the portal framework discussed in relation to FIG. 6) for communication devices, such as phones and other thin-client devices, peer-to-peer “in-call” application level negotiation and user interface customization for thin-client devices (discussed in relation to FIG. 7). Also, the event mechanisms in SIP facilitate start, stop, manage, and control sessions that carry IPTML constructs from one UA to another.

The IPTML Card 302 may be used to monitor communication events occurring at communication devices and control certain aspects of the communication devices through directives. Event construct 306 includes signaling and communication device events, also referred to as events herein, include for example, incoming calls, incoming messages, remote alert, remote connect, remote error, local error and various other events that can occur on a communication device, such as an IP terminal. Event construct 306 is discussed in more detail in relation to FIG. 3B.

Directive construct 308 represents actions that a communication device can perform, such as dial a number or activate an indicator, such as an LED (light emitting diode). Directive construct 308 is discussed in more detail in relation to FIG. 3C.

Render construct 310 is used for capturing communication device interface events. Render construct 310 include, for example, displaying data, operating LEDs, and providing ringback tones and stutter tones to communication devices. Render construct 310 is discussed in more detail in relation to FIG. 3D.

OnEvent construct 312 is a mechanism to script a dependency, relationship or correspondence between communication devices. It is possible to script a rendering or a directive or a fetch based on the occurrence of an event. OnEvent construct 312 is discussed in more detail in relation to FIG. 3E.

Event Construct

FIG. 3B shows a representation of an IPTML Event construct 306. As stated previously, IPTML Events are communication events that occur in a communication device, typically an IP terminal end-point. The Event construct in IPTML captures the events that occur at the communication device. These events may be defined as signaling events, terminal events media events and other events. Usually, these events are used for notification purposes.

The Event construct 306 is shown as including constructs for: Button event 313, which may be triggered by certain keys on the communication device, such as, for example, a “hold” button or a “transfer” button to report buttons pressed at a device (and can optionally include the current context of the call); Menu event 321, which may be triggered by selection of one or more menu keys on the communication device to indicate the user (device) event that a menu item has been selected; InComingCall event 322, which occurs when there is a signal on the communication device indicating that there is a request for an incoming call; RemoteAlert event 323, which occurs when there is an indication that a remote party has been alerted; RemoteConnect event 324, which occurs when there is an indication that the remote party has accepted a call; RemoteDisconnect event 325, which occurs when the remote party disconnects a call; RemoteError event 326, which indicates an error that a terminal receives from the remote party; RemoteRedirect event 327, which indicates a redirect from the remote party; and incoming message event 328, which indicates that an instant message has been received at the communication device.

ListSelect 328-a indicates the user (device) event that a list item has been selected; DeviceList 328-b indicates the list of devices that are associated with the user; LocalError 328-c indicates an error; LineStatus 328-d indicates the status of a line (response to LineSelect); and MediaStatus 328-e indicates the status of a media resource (response to a MediaReserve).

Button event construct 313 further includes connection facility 375, which is used to select one or more of Button 314 and Button State indicator 315. Button 314 includes Name indicator 316 and Button State 315 includes State indicator 317. The Name indicator 316 may be the name of a calling party or other identifying information for the calling party. The State indicator 317 may be an indication of the operational state of a communication device.

IncomingCall event construct 322 is coupled to connection facility 376, which enables selection between data items that form the IncomingCall event construct 322. These include: Terminal construct 318; From construct 329; To construct 332; Media construct 333; and Body construct 334.

Terminal construct 318 is coupled, via connection facility 377, to Terminal ID 319 and Line Number 320, which collectively define a communication device 370. The communication device 370 provides the terminal identification data and line number data as output.

From construct 329 is coupled, via connection facility 378, to URL indicator 330 and Name indicator 331, which are outputs for communication device 372 that indicate a Uniform Resources Locator address and a name of a transmitting party, respectively.

Media construct 333 is coupled, via connection facility 379, to MIME Type indicator 335, Connection indicator 336 and MediaType indicator 337, which are outputs for communication device 374 that indicate the type of media of a communication event.

Body construct 334 indicates message content of a communication event.

Directive Construct

FIG. 3C shows a representation of an IPTML Directive construct 308. In addition to monitoring events, IPTML provides applications to control certain aspects of a communication device through directives. These directives are used to drive communication session control, communication media, and UI (user interface) aspects of the communication device. Examples of IPTML Directives, which may be issued to a communication device, are discussed below.

Directive construct 308 is coupled, via connection facility 380, to: Send Message construct 338 that directs a communication device to send an instant message; LineSelect construct 346 which directs a communication device to select a particular line for making calls; Make Call construct 347 which issues a dial command with a dial string; Button Press construct 348, enables a communication device to process a button press event; RenegotiateMedia construct 348-a is a command to alter the media destination within a call; SendData construct 348-b is a command to send data between two IPTML devices that are connected in a call; RingTone construct 348-c that activates a ring tone on a device; LightLamp construct 348-d that activates a lamp on a device; Input construct 349, directs a communication device to process input from a user, such as input from a keyboard, mouse or other input facility; Transfer construct 349-a; Configure construct 350, issues a command to add name-value parameters to a communication event (configures media and device settings); Hangup construct 350-a; MediaStart construct 351, directs a communication device to start media either locally or remotely; Device information construct 351-a is a command to obtain information about a user's devices; MediaStop construct 352, directs the communication device to stop media either locally or remotely; Answer construct 352-a; Media Reserve Construct 352-b is a command to reserve media before negotiating and before issuing; and Line Deny construct 352-c.

As shown in FIG. 3C, the SendMessage construct 338 includes: connection facility 381; Terminal construct 339, which includes information related to a particular communication device; From construct 342, which includes information relating to a transmitting station or party; To construct 343, which includes information relating to recipient party or recipient station; Media construct 344, which includes information relating to the type of media such as voice, data or a combination of media; and Body construct 345, which includes information relating to the text or content of a transmission or communication.

Terminal construct 339 includes: connection facility 382; TerminalID 340, which identifies a particular sender communication device; and LineNumber 341, which identifies a particular sender line.

Render Construct

FIG. 3D shows a representation of a Render construct 310, which provides display output and allows embedding independent scripts such as WML, XHTML and other markup languages into the output. The embedding feature enables advanced rendering capabilities of communication devices to be exploited in IPTML scripts. Render construct 310 is coupled to Display construct 353, DisplayMenu construct 354, display list construct 354-a, input construct 354-b and data construct 354-c via connection facility 383.

Display construct 353 can be used to display plain text, images, or embed other markup languages, such as HTML (shown as element 355), to DisplayUnit construct 375, which may be WML, HTML, XHTML or other markup language(s).

DisplayMenu construct 354 can present users several choices, via connection facility 384, such as Name 356 Display 357 and MenuMap 358. The MenuMap construct 358 includes connection facility 385, Key 359 and Label 360. Directive construct 308 or an OnEvent scripting mechanism 312 will be performed when based on a selection using connection facility 386. The data construct 354-c can render data based on mimetype information via a connection facility.

OnEvent (Scripting) Construct

FIG. 3E shows a representation of an OnEvent construct 312. OnEvent construct 312 is a scripting mechanism that enables applications to combine functionalities of the Event construct (shown in FIG. 3A as element 306), Directive construct (shown in FIG. 3A as element 308), and/or Render construct (shown in FIG. 3A as element 310). OnEvent construct 312 includes connection facility 387, EventName construct 363, On Timer construct 363-a and On Go construct 363-b and connection facility 388. EventName construct 363 includes connection facility 389 and Name 364. EventName construct 363 and Name construct 364 may be used to identify a name of an event.

OnEvent construct 312, as shown in FIG. 3E, is coupled, via connection facility 388, to: Go construct 365, which enables the communication device to receive and/or transmit a communication; ReportEvent construct 366, which provides a reporting of the communication; Directive construct 308 and Render construct 310, which were previously described.

Thus, the above-described IPTML constructs allow several features of a communication device to be encapsulated in a device abstraction layer. The device abstraction layer consists of the following abstractions:
1) device control and event reporting functions (including session state and context, media, feature invocation, communications, and user interface aspects);
2) configuration and discovery of device communication capabilities;
3) providing links to presentation, input collection and web content (such as the Display, DisplayMenu, DisplayList, MenuSelect ListSelect, Input primitives discussed below); and
4) scripting capabilities for aggregated device control (such as the OnEvent primitive, discussed below, based on a certain event or trigger, can issue a directive, such as a “go” command).
   The device control and event reporting functions include events/directives that may contain session information that ties a usage to a particular communication session:
(i) device control and event reporting (such as the ButtonEvent, ButtonState, Hold, Conference, Speaker, OnHook, OffHook, LineSelect and LineStatus primitives);
(ii) session state and context control and event reporting (such as the IncomingCall, RemoteAlert, RemoteConnect, InstantMessage, IMResponse, RemoteReconnect, LineDeny, LineRenegotiate and LineTransfer primitives); and
(iii) media (such as the MediaStart, MediaStop, MediaReserve and MediaStatus keywords).

A number of examples of how these primitives may be employed in various applications of the present invention are discussed below in a section entitled “IPTML Examples.”

IPTML Construct Algorithm FIG. 4 is a flow chart describing an exemplary implementation of an IPTML construct algorithm 400. Generally, the IPTML construct algorithm 400 can modify operation of a communication device, such as those devices shown in FIG. 2, using one or more IPTML constructs. These steps, or functional features, are shown as blocks and are suitably stored on a computer-readable medium, which can be read by a computer, or other processing device as described herein.

As shown in FIG. 4, the IPTML construct algorithm 400 is initiated during step 402. Step 404 identifies operation of a communication device (for example, telephone device 172 shown in FIGS. 1 and 2). This identification may include, for example, monitoring the status of the communication device and/or controlling operation of the communication device. Decision step 406 determines whether an event has occurred, or is occurring. The event may be, for example an incoming call incoming message, off-hook condition or I/M. If no event is detected, line 405 shows that step 404 continues until an event is detected.

When an event is detected, line 407 shows that step 408 accesses abstraction data, which may include one or more of: communication device or terminal data, which includes information about the functional capabilities of the communication device (for example telephone 172, personal computer 176, telephone 150 and personal computer 152 shown in FIG. 2), such as call waiting, call forwarding, and conference calling; signal data, which includes signals to indicate an incoming call, signals to indicate an incoming voice message, signals to indicate an I/M; and media data, which includes identification of voice data, image data, or other type of data.

The abstraction data is an IPTML representation of the actual event and each event can have an associated abstraction. Step 410 generates an application, for a communication device (for example telephone 172, personal computer 176, telephone 150 and personal computer 152 shown in FIG. 2), as a function of the abstraction data. This application is typically generated using IPTML. Step 412 provides the application to a particular communication device (for example telephone 172, personal computer 176, telephone 150 and personal computer 152 shown in FIG. 2). Step 414 modifies operation of the communication device (for example telephone 172, personal computer 176, telephone 150 and personal computer 152 shown in FIG. 2) as a function of the abstraction data. Step 416 ends the algorithm.

Specific examples that utilize an IPTML construct to generate applications for communication devices include: 1) a personal computer coupled to a telephone unit; 2) a portal framework for a plurality of communication devices; and 3) a peer-to-peer embodiment. These examples are discussed in more detail below.

### Personal Computer Coupled to a Telephone Unit

FIG. 5 is an algorithm 500 to generate a response to a communication event using a telephone and personal computer, which are coupled together (for example FIG. 2 shows telephone 172 coupled to personal computer 176 and telephone 150 coupled to personal computer 152). The algorithm 500 modifies operation of the telephone using an IPTML construct (as discussed in relation to FIGS. 3A through 3E). For example, a communication session, such as a telephone call is initiated to a telephone device (element 172 of FIG. 2) that operates an IPTML parser. The telephone device (element 172 of FIG. 2) recognizes the incoming call and generates an IPTML event in response. This IPTML event can be transmitted to other communication devices, such as a personal computer coupled to the telephone device of the calling participant (element personal computer 176 of FIG. 2). The participants (caller party, called party and other teleconference parties) in the communication session can then determine whether they wish to initiate a video conference.

The algorithm is initiated during step 502. In step 504 the personal computer (element 176 of FIG. 2) monitors operation and/or state of the telephone device (element 172 of FIG. 2). Decision step 506 determines whether a communication event is detected at the telephone device (element 172 of FIG. 2). If no communication event is detected, line 507 shows that the personal computer (element 176 of FIG. 2) continues monitoring operation of the telephone device (element 172 of FIG. 2). When a communication event is detected, step 508 generates abstraction data, which is IPTML, as a function of the communication event at the telephone device (element 172 of FIG. 2). This communication event may be, for example, an incoming call or incoming message or off-hook condition. The abstraction is a representation of the particular communication event. Step 510 transmits abstraction data from the telephone device (element 172 of FIG. 2) to the personal computer (element 176 of FIG. 2) that is coupled to the telephone device (element 172 of FIG. 2). Step 512 generates an IPTML response, at the personal computer (element 176 of FIG. 2), based on the abstraction data. Step 514 transmits the response from the personal computer (element 176 of FIG. 2) to the telephone device (element 172 of FIG. 2). Step 516 modifies operation of the telephone device (element 172 of FIG. 2) based on the response received from the personal computer (element 176 of FIG. 2). Decision step 518 determines whether there are any user input signals. If so, “yes” line 520 leads to step 522 that provides the user input to the personal computer (element 176 of FIG. 2) to generate the response as a function of the abstraction data and the user input (step 512). If there are no user input signals, “no” line 524 leads to end step 526.

Alternatively, the telephone device (element 172 of FIG. 2) could monitor the personal computer (element 176 of FIG. 2) and an event at the personal computer (element 176 of FIG. 2) could be transmitted, as an abstraction to the telephone device (element 172 of FIG. 2).

While FIG. 5 shows an algorithm 500 using a telephone and personal computer, which are coupled together, it is a further embodiment of the present invention that multiple couplings of personal computer's and telephones could be used to provide enhanced features to for a communication session. For example, as shown in FIG. 2, personal computer 176 is coupled to telephone device 172 and personal computer 152 is coupled to telephone device 150. A communication session that started as a voice call from telephone device 150 to telephone device 172 could include identifying that both telephones 150 and 172 have video conferencing capability. This could be achieved by providing an indication of the incoming call to telephone 172 to the associated or companion communication device, personal computer 156, which has video conferencing capability. The telephone device 172 can indicate to the transmitting telephone 150 that video conferencing is possible. The telephone 150 is coupled to personal computer 152, which also has video conferencing capability, and a video conference can be initiated such that voice data is transmitted via the telephone devices 150, 172 and video data is transmitted via the personal computer's 152, 176. Thus, the voice call communication session could be enhanced to include a video conference.

### Portal Framework for a Plurality of Communication Devices

FIG. 6 is an algorithm 600 to generate a response to a communication event using a portal framework. The algorithm 600 provides information to a communication device (as discussed in relation to FIGS. 1 and 2) via a web portal, using IPTML. The use of a web portal enables delivery of communications to less sophisticated communication devices, or end terminals, through an applications portal, which is easily installed, upgraded and administered.

The algorithm is initiated during step 602. Step 604 monitors operation of a first communication device (for example, personal computer 176 shown in FIG. 2). Step 606 determines whether a communication event is detected. If a communication event is not detected, the monitoring operation continues at step 604. When a communication event is detected, communication event information is provided at step 610, using an IPTML construct, in response to the communication event to the communication device (personal computer 176 shown in FIG. 2), via a web portal. Step 612 generates a response to the communication event information at the communication device (personal computer 176 shown in FIG. 2). Step 614 transmits the response from the first communication device (personal computer 176 shown in FIG. 2) to another communication device (personal computer 152 shown in FIG. 2). Step 616 ends the algorithm.

### Peer-to-Peer

FIG. 7 is an algorithm 700 to generate a response to a communication event using a peer-to-peer framework. The algorithm is initiated during step 702. Step 704 establishes a communication channel between two or more communication devices, such as telephones, or personal computers or applications operating on communication devices. Step 706 accesses abstraction data at a first communication device. Step 708 transmits abstraction data, such as terminal data, signal data and/or media data, in IPTML format from the first communication device to a second communication device via the established channel. Step 710 generates a response to the abstraction data. The response is also in IPTML format. Step 712 modifies operation of the second communication device as a function of the response. Step 714 ends the algorithm.

For example, two parties may be participating in a communication session, which is a voice call session using a caller party telephone and a called party telephone. The voice call establishes a communication channel and when the voice session is terminated, the communication channel remains open for another transmission, such as text file, such as business card data, which is sent using the established channel.

### IPTML EXAMPLES

The IPTML scripting language disclosed herein may be used to implement the following examples:

### Example 1

IPTML allows communication devices to be augmented with additional media capabilities on other devices. For example, the first example allows audio, video, IM or inkpad capabilities to be added to or removed from an existing call. The first example allows IPTML to “configure” an endpoint with additional media capabilities. In other words, an IPTML phone can be configured by an associated PC or application so that the PC can handle the video for a call. The IPTML endpoint then negotiates an audio-video call with another endpoint and the IPTML endpoint controls the video media at the associated PC through IPTML.

The first example employs the following attributes of IPTML: Configure, Session Context (DeviceID and Line Number), Media control (Media Start, Media Stop, Media Reserve), DisplayList/DisplayMenu, MenuSelect/ListSelect, Renegotiation.

IPTML enabled devices (for example, a PC with video capability and a phone that handles audio and signalling) can communicate with each other through IPTML, discover capabilities and include the aggregated capabilities as part of the communication session (from the phone).

In the case of a PC that provides a video capability and a desktop phone that provides the audio capability, the following exemplary sequence of actions enables an aggregated view:

1. PC establishes an IPTML session with Phone.

2. PC sets up the video media to be delivered to its address (through configure).

3. Phone stores the PC's information as an augmented video media device.

4. Phone makes a call to another endpoint indicating that the phone can process audio and video communications and provides media parameters to the other endpoint (phone's address for audio and PC's address for video). At this point, the phone may reserve the video media on the PC.

5. Once an audio/video call is connected, the phone starts the audio media and issues an IPTML command, StartMedia, for video to the PC along with the video parameters of the remote party;

6. The PC, upon receiving a StartMedia command, starts the video.

7. Once the media is established, any changes to the call on the phone, for example, Hold, Unhold, or Hangup, will be reflected appropriately through the MediaStart/Stop commands.

8. When the call is terminated, a MediaStop command is sent.

This mechanism provides an augmented view of the phone along with devices that are willing to collaborate and share their capabilities.

### Example 2

IPTML allows a display to be associated with a call session. For example, an IPTML endpoint can make a call to a voice mail server, and the voice mail server responds to the endpoint with voice and IPTML code for the display. The IPTML display indicates the choices that are available through voice and touchtone.

The second example employs the following attributes of IPTML: Session Context, Dial, DisplayMenu/DisplayList, Menu/LineSelect, Data and Scripting.

The second example allows an IPTML-enabled voice mail server establishes IPTML sessions with callers (with IPTML devices) to push content to match the audio output of the server. The following exemplary sequence of actions may be performed:

1. User of an IPTML phone calls a voice mail server.

2. Voice mail server (such as the server 180) attaches an IPTML session with the phone call.

3. Voice mail server gets the user's identity from the call, fetches messages, constructs IPTML documents using DisplayMenu or DisplayList commands, as appropriate, to display the message information and sends it to the phone.

4. The voice mail server will also provide an audio feedback of the same information.

5. The user at the phone has the choice of responding to the audio or by using the display. In the latter case, IPTML constructs MenuSelect or LineSelect are used by the phone, as appropriate, to send choices back to the voice mail server.

6. The voice mail server, upon receiving the user selections (Menu/ListSelect), can act accordingly. For example, selecting a particular message will force the voice mail server to fetch the message, play the message (audio) and render choices to the user on the phone, for example, to reply, delete or see the presence information of the caller.

7. The IPTML session terminates when the call is disconnected.

### Example 3

The third example allows a higher priority application to pre-empt the current resources of a device. For example, an enterprise portal can push alerts by taking over the speaker and display of a device.

The third example employs the following attributes of IPTML: Media Control (MediaStart, MediaStop), Device Control (Speaker on/off) and display control (such as DisplayMenu and DisplayText) and Scripting.

An enterprise web portal can send a high priority IPTML alert, such as a button event to go off hook (Speaker on), a MediaStart, and/or a rendering directive, such as Display with parameters to listen to a corporate wide announcement.

### Example 4

According to a fourth example of IPTML, a PDA or Microsoft exchange enabled device can send data (such as a VCard or Vcalendar) over an existing session between two devices (phones).

The fourth example employs the following attributes of IPTML: Session Information, and Embedding and Sending Vcard, Vcal as IPTML Data.

The following exemplary sequence of actions can accomplish the fourth example:

1. A VoIP call is established between two IPTML enabled phones.

2. The first phone has an IPTML channel with a PC running Microsoft Exchange.

3. From Microsoft Exchange, the user on the first phone can send a vCard as an IPTML attachment to the first phone, and then from the first phone 1.

4. The first phone then can use its existing data channel or establish a data channel to send the IPTML embedded vCard to the second phone.

5. The second phone receives the IPTML embedded vCard, parses it, extracts the vCard, and can beam it to a PDA or store the vCard.

### Example 5

A fifth example of IPTML manages media on several devices. For example, users can pick up a call on a cell phone, walk into their office and automatically transfer the media to their desk phone.

The fifth example employs the following attributes of IPTML: Session Information, Media Control, Session Control (starting of a session, renegotiating a session).

The fifth example employs an IPTML server. All endpoints establish IPTML channels to the IPTML server that can control and render features, such as managing media on several devices (composition or aggregation), shared control and bridging. For example, the fifth example allows a user to log on to the IPTML server from several devices, make an audio/video call and then decide to move the audio portion of the call from his or her desktop phone to his or her cell phone.

The following exemplary sequence of actions can implement the fifth example;

1. The phones establish an IPTML channel to the server.

2. The phones of a particular user are aggregated based on their capabilities (for example, video/audio), presence, preference, and availability. In other words, a user might be logged on from his or her cell phone, desktop phone, PC or PDA but may wish to take an audio call only on the desktop phone.

3. An audio/video call comes in to the preferred device (such as phone 1).

4. Phone 1 then reserves video through the IPTML server to find out and reserve what other devices and their resources are available for this call.

5. The call is completed with audio going to the phone and video going to the video device.

6. The user desires to hang up on the desktop phone, but pickup the call on his or her cell phone. Phone 1 sends out an IPTML query for other audio devices (DeviceInfo).

7. IPTML server then lists the available devices (DeviceList) on Phone 1.

8. The user at Phone 1 can select an indicated device, such as cell phone.

9. The IPTML server sends a LineRenegotiateMedia command to phone 1.

10. Phone 1, upon receiving the LineRenegotiateMedia command, modifies the call to send the audio to the cell phone and the video to the video device.

### Example 6

A further example of IPTML allows a phone to be controlled and manipulated from an application (such as a companion application sharing control of a phone).

The sixth example employs the following attributes of IPTML: Session Control (receiving session events such as RemoteConnect, and issuing directives, such as Dial), Media Control, and Device Control.

The following exemplary sequence of actions can implement the sixth example:

1. A PC establishes an IPTML channel with a phone.

2. The PC can send directives and events to the phone. For example, an application on the PC can cause the phone to go off hook by sending an OFFHOOK directive. Subsequently, a call can be initiated by sending the DIALDIGITS directive.

3. The phone can send directives and events to the PC. For example, the phone may report an incoming call event to the application on the PC. The PC uses this information to alert the user to the fact that a call has been received at the phone.

### Example 7

The device events aspect of IPTML allows telephony features associated with a session, such as bridging and conferencing.

The seventh example employs a similar set of IPTML attributes as the sixth example, but only uses a subset of events and directives.

For example, the implementation of a line appearance on a phone device A that bridges to (or mirrors the state of) a corresponding line appearance on another phone device B would be accomplished as follows. When a user picks up phone B to place a call, a line appearance is selected for that outgoing call. This selection is rendered appropriately to the user. Phone B sends an IPTML LineSelect directive to Phone A, identifying the line appearance. Phone A uses this information to render the line selection appropriately.

### Example 8

An eighth example of IPTML allows scheduling appointments and dropping them in a calendar application, such as Microsoft Exchange, during a call.

The eighth example employs a similar set of IPTML attributes as the fourth example.

### Example 9

A further example of IPTML schedules a conference call with an access number and pushes the conference call at the scheduled time to the device.

The ninth example employs the following attributes of IPTML: DisplayMenu/List, Menu/ListSelect, Dial and Scripting.

The following exemplary sequence of actions implement the ninth example:

1. An enterprise wide web-portal (see example 2) or an application running on a PC (see example 6) can push IPTML DisplayMenu/List to a phone with options to enable a conference.

2. Users on the phone can select conference option.

3. The IPTML can be authored either to send the selection of a particular conference back to the portal or application, or it can be authored to include a scripting mechanism which dials out an extension along with the access code when the conference option is selected.

4. The directive “Dial” is issued either by the portal (or application) or by the scripting engine.

### Example 10

The tenth example allows context for calls. For example, after ordering towels for his/her room, a hotel guest can then later browse through his/her request and can start an audio session that contains information about the request. Similarly, audio sessions can also be triggered based on requests in a call center.

The tenth example employs the following attributes of IPTML: Session Information, DisplayMenu/List, Menu/ListSelect, Data and Scripting.

The tenth example can implement a similar sequence of events as the second example.

### Example 11

Yet another example of IPTML allows manipulation of media streams at and across devices. For example, the voice stream coming into a phone can be tapped and sent to a recording device.

The eleventh example employs the following attributes of IPTML: Session Events (such as InComingCall), Directives (Renegotiate), MediaControl, Configure and Scripting.

The following exemplary sequence of actions can implement the eleventh example:

1. The recording device establishes an IPTML channel to the phone.

2. The phone is configured to render media to the recording device (also).

3. Once the call is completed, the phone issues a MediaStart directive with the remote media parameters.

4. The recording device starts an audio channel with the remote party after receiving the MediaStart directive.

5. A media session starts until the call is disconnected or put on hold.

### Example 12

Another example allows scripting of actions at a device by an application, such as:

a) prompt the user for input on an incoming session invitation;

b) dialplan for sequencing digits that trigger outgoing calls augmented with audible alerts or display updates (“You are dialing an outside line”);

c) context sensitive help menus rendered either on display or voice or both;

This example employs the following attributes of IPTML: Session Events (such as InComingCall or RemoteConnect), ButtonEvents, MediaControl, DisplayMenu/List, Menu/ListSelect and Scripting.

In one implementation, the following sequence of actions is performed:

1. The application has an IPTML channel to the phone.

2. When the application receives an IncomingCall event, the application will generate a menu, a list or both on the phone with DisplayMenu/DisplayList directives.

3. Rendering the dispaly directives presents users at the phone with different choices, for example, answer, reject, forward, reply or later.

In another implementation, the following sequence of actions is performed:

1. An application has an IPTML channel to the phone.

2. When a user goes off-hook or turns on the speaker and starts dialing, the phone generates button events.

3. The application collects the button events and can trigger audio alerts by a MediaStart directive.

In yet another implementation, a sequence of actions similar to the voice mail server application (example 2) is performed.

The steps, or functional features, of FIGS. 4 through 7 are shown as blocks and are suitably stored on a computer-readable medium, which can be read by a computer, or other processing device as described herein. The steps FIGS. 4 through 7 may be used to generate program code or perform a series of data manipulations. While FIGS. 4 through 7 show steps in a particular sequence, this is for explanation purposes, and it is within the scope of the invention that the specific sequence may be modified as a function of specific applications, program code and design considerations.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A method for generating an application for a communication device, comprising the steps of:
identifying operation of the communication device;
accessing abstraction data related to the communication device; and
generating an application that modifies the operation of the communication device as a function of the abstraction data.

2. The method of claim 1, further comprising the step of generating the abstraction data from one or more of: communication device data, signal data and media data.

3. The method of claim 1, further comprising the step of generating the abstraction data using an Internet Protocol Terminal Markup Language (IPTML) that comprises one or more of event construct, directive construct, render construct and scripting construct.

4. The method of claim 1, further comprising the step of providing the application to the communication device.

5. The method of claim 4, further comprising the step of modifying the operation of the communication device as a function of the application.

6. The method of claim 1, wherein said abstraction data encapsulates one or more of device control functions, event reporting functions or device capabilities.

7. The method of claim 1, wherein said generating step augments said communication device with one or more additional media capabilities

8. The method of claim 1, wherein said generating step associates a display with an audio portion of a call session.

9. The method of claim 1, wherein said generating step allows a higher priority application to pre-empt resources of a device.

10. The method of claim 1, wherein said generating step transmits data over an existing session between two devices.

11. The method of claim 1, wherein said generating step manages media on a plurality of communication devices to allow media on one device to be transferred to another device.

12. A method for generating a response to a communication event, comprising the steps of:
monitoring operation of a communication device;
receiving abstraction data as a function of the operation of the communication device; and
generating a response as a function of the abstraction data.

13. The method of claim 12, further comprising the step of providing the response to the communication device.

14. The method of claim 13, further comprising the step of modifying operation of the communication device as a function of the response.

15. The method of claim 12, wherein the abstraction data comprises Internet Protocol Terminal Markup Language (IPTML) that comprises one or more of an event construct, a directive construct, a render construct and a scripting construct.

16. A method for providing a response to a communication event, comprising the steps of:
monitoring operation of a communication device;
providing abstraction data to the communication device via a web portal; and
triggering generation of a response to the abstraction data at the communication device.

17. The method of claim 16, further comprising the step of triggering transmission of the response from the communication device to a selected communication device.

18. The method of claim 17, wherein the selected communication device is associated with a second web portal.

19. The method of claim 18, wherein the communication device is associated with the web portal.

20. The method of claim 16, wherein the abstraction data is selected from one or more of: terminal data, signal data and media data.

21. A method for interfacing between two or more communication devices, comprising the steps of:
accessing abstraction data representative of an event;
establishing a communication channel between the two or more communication devices;
receiving the abstraction data at a second communication device from a first communication device over the communication channel; and
generating a response to the abstraction data at the second communication device.

22. The method of claim 21, wherein the abstraction data is selected from one or more of: communication device data, signal data and media data.

23. The method of claim 21, wherein the abstraction data comprises Internet Protocol Terminal Markup Language (IPTML) that comprises one or more of an event construct, a directive construct, a render construct and a scripting construct.

24. A system for generating an application for a communication device, comprising:
a memory; and
at least one processor, coupled to the memory, operative to:
identify operation of the communication device;
access abstraction data related to the communication device; and
generate an application that modifies the operation of the communication device as a function of the abstraction data.

25. An article of manufacture for generating an application for a communication device, comprising a machine readable medium containing one or more programs which when executed implement the steps of:
identifying operation of the communication device;
accessing abstraction data related to the communication device; and
generating an application that modifies the operation of the communication device as a function of the abstraction data.
